(19) United States
(12) Patent Application Publication
(10) Pub. No.: US 2026/0131743 A1
(43) Pub. Date: May 14, 2026

(54) ADAPTER STRUCTURE FOR VEHICLE

(71) Applicant: Ford Global Technologies, LLC, Dearborn, MI (US)

(72) Inventors: Mohammed Michael Baydoun, Dearborn Heights, MI (US); Anthony Lavdas, Macomb Township, MI (US); Michael Beckley, Van Buren Township, MI (US); Hassan A. Haidar, Dearborn Heights, MI (US); Alexander Studnicka, Macomb, MI (US)

(73) Assignee: Ford Global Technologies, LLC, Dearborn, MI (US)

(21) Appl. No.: 18/947,711

(22) Filed: Nov. 14, 2024

(51) Int. Cl. B60R 16/02; H02G 3/32

(52) U.S. Cl. CPC B60R 16/0215; H02G 3/32

(57) ABSTRACT

An adapter structure for a first opening in a frame includes a stem and a plurality of flexible wings. The stem is configured to be received in the first opening of the frame and defines a longitudinal axis. The stem includes a second opening extending at least partially therethrough along the longitudinal axis and configured to receive a fastener. The plurality of flexible wings extend radially outward from the stem.

### FIELD

The present disclosure relates to an adapter structure for a vehicle and more particularly to an adapter retainer for a frame of the vehicle.

### BACKGROUND

The statements in this section merely provide background information related to the present disclosure and may not constitute prior art.

Fasteners may be used to secure components (e.g., wire bundles, fluid lines) to structures of vehicles. In some instances, it may be challenging to couple the fasteners to the structures of the vehicle particularly when the openings of the structures are non-circular. In this way, the vehicle may include a plurality of fasteners of different design used to secure components to different locations of the vehicle.

The teachings of the present disclosure address these and other issues with fasteners used to secure components to structures of vehicles.

### SUMMARY

This section provides a general summary of the disclosure and is not a comprehensive disclosure of its full scope or all of its features.

In one form, the present disclosure provides an adapter structure for a first opening in a frame. The adapter structure includes a stem and a plurality of flexible wings. The stem is configured to be received in the first opening of the frame and defines a longitudinal axis. The stem includes a second opening extending at least partially therethrough along the longitudinal axis and configured to receive a fastener. The plurality of flexible wings extend radially outward from the stem.

In variations of the adapter structure of the above paragraph, which can be implemented individually or in any combination: the stem includes a distal end and a proximal end, the stem comprises a constant shape from the distal end towards the proximal end; the adapter further includes a wall extending radially outward from a proximal end of the stem a further distance than the plurality of flexible wings; the wall defines a third opening that is in communication with the second opening and that is configured to receive the fastener; a first flexible wing of the plurality of flexible wings extends radially outward from or near a distal end of the stem a first distance and a second flexible wing of the plurality of flexible wings extends radially outward from or near a proximal end of the stem a second distance, the second distance is greater than the first distance; the stem includes a distal end and a proximal end, the stem has a constant thickness from the distal end towards the proximal end; the plurality of flexible wings extend further from the stem in a radial direction as the plurality of flexible wings move closer from a distal end of the stem toward a proximal end of the stem; the stem has an oval shape; the stem includes an inner surface that defines the second opening and an outer surface, the plurality of flexible wings extend radially outward from the outer surface of the stem; the adapter structure further includes a fastener.

In another form, the present disclosure provides an adapter structure for a first opening in a frame. The adapter structure includes a first stem, a plurality of first flexible barbs, and a fastener. The first stem is configured to be received in the first opening of the frame and defines a longitudinal axis. The first stem comprises a second opening extending at least partially therethrough along the longitudinal axis. The plurality of first flexible barbs extend radially outward from the first stem. The fastener includes a second stem and a plurality of second flexible barbs extending radially outward from the second stem. A portion of the second stem and the plurality of second flexible barbs at least partially received in the second opening.

In variations of the adapter structure of the above paragraph, which can be implemented individually or in any combination: the first stem includes a distal end and a proximal end, the first stem comprises a constant shape from the distal end towards the proximal end; the adapter structure further includes a first wall extends radially outward from a proximal end of the first stem a further distance than the plurality of first flexible barbs; the adapter structure further includes a second wall extending radially outward from an end of the second stem a further distance than the plurality of second flexible barbs; the first wall defines a third opening that is in communication with the second opening and that is configured to receive the portion of the second stem and the plurality of second flexible barbs; a first flexible barb of the plurality of first flexible barbs extends radially outward from or near a distal end of the first stem a first distance and a second flexible barb of the plurality of first flexible barbs extends radially outward from or near a proximal end of the first stem a second distance, the second distance is greater than the first distance; the plurality of first flexible barbs extend further from the first stem in a radial direction as the plurality of first flexible barbs move closer from a distal end of the first stem toward a proximal end of the first stem; the first stem includes an inner surface that defines the second opening and an outer surface, the plurality of first flexible barbs extend radially outward from the outer surface of the stem; and the plurality of second barbs engage the inner surface of the first stem.

In yet another form, the present disclosure provides a vehicle that includes a vehicle frame and an adapter structure. The vehicle frame defines a first opening. The adapter structure includes a first stem, a plurality of flexible barbs, and a fastener. The first stem is configured to be received in the first opening of the vehicle frame and defines a longitudinal axis. The first stem includes a second opening extending at least partially therethrough along the longitudinal axis. The plurality of first flexible barbs extend radially outward from the first stem. The fastener includes a second stem and a plurality of second flexible barbs extending radially outward from the second stem. A portion of the second stem and the plurality of second flexible barbs at least partially received in the second opening such that the plurality of second flexible barbs engage an inner surface defining the second opening. A first flexible barb of the plurality of first flexible barbs extends radially outward from or near a distal end of the first stem a first distance and a second flexible barb of the plurality of first flexible barbs extends radially outward from or near a proximal end of the first stem a second distance. The second distance is greater than the first distance.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including an adapter structure according to the principles of the present disclosure;

FIG. 2 is a bottom view of a vehicle frame of the vehicle of FIG. 1;

FIG. 3 is a perspective view of the adapter structure of FIG. 1 coupling a vehicle component to the vehicle frame;

FIG. 4 is an exploded view of the adapter structure of FIG. 1;

FIG. 5 is another exploded view of the adapter structure of FIG. 1;

FIG. 6 is a perspective view of an adapter retainer of the adapter structure of FIG. 1;

FIG. 7 is a cross-sectional view of the adapter structure of FIG. 1 taken along line 7-7 of FIG. 3; and

FIG. 8 is another cross-sectional view of the adapter structure of FIG. 1 taken along line 8-8 of FIG. 3.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

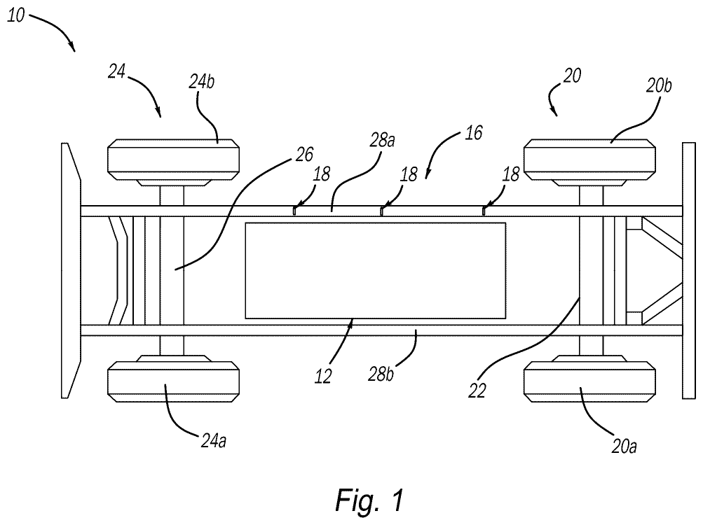

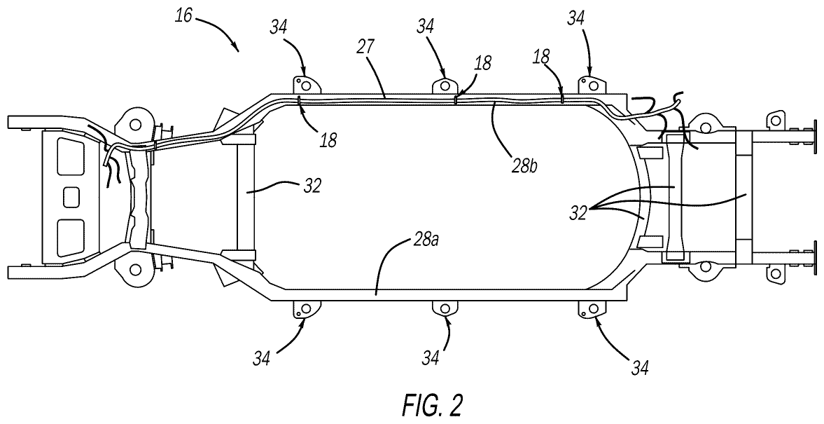

With reference to FIGS. 1 and 2, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle. The vehicle 10 includes a battery structure 12, a vehicle body (not shown), a vehicle frame 16, and a plurality of adapter structures or adapter assemblies 18. The battery structure 12 may be rechargeable and may include lithium-ion batteries, solid-state batteries, or any other suitable electrical power storage units. The battery structure 12 may be disposed at various locations of the vehicle 10 and may be secured to the vehicle frame 16 via a battery pack support assembly (not shown). In this way, the battery structure 12 is supported by the vehicle frame 16 and is remote from a passenger cabin and cargo compartments (not shown) of the vehicle 10, therefore, not occupying space that would otherwise be available for passengers or cargo. The battery structure 12 powers one or more motors to drive a set of drive wheels. For example, the battery structure 12 may power a rear motor (not shown) to drive rear wheels 20a, 20b of a set of rear wheels 20 via a rear axle 22 and/or may power a front motor (not shown) to drive front wheels 24a, 24b of a set of front wheels 24 via a front axle 26.

The vehicle body (not shown) may be separate (distinct) from and mounted on the vehicle frame 16. Stated differently, the vehicle body is mounted on a plurality of mounts 34 (FIG. 2) secured to the vehicle frame 16. Jounce bumpers may be disposed on a respective mount 34 and between the respective mount 34 and the vehicle body. The vehicle body also includes a front end (not shown), a plurality of pillars (not shown), side rails (not shown), and rockers (not shown). In one example, the front end includes a bumper, a pair of opposed beams or inner rails (not shown), and a pair of opposed upper rails (not shown). The bumper extends in a transverse direction relative to a longitudinal direction of the vehicle 10 and is secured to the vehicle frame 16.

With reference to FIG. 2, the vehicle frame 16 is made of a metal material such as high strength steel, for example, and may be manufactured by a roll forming process, for example. The vehicle frame 16 is the main supporting structure of the vehicle 10, to which various components are attached either directly or indirectly. For example, a suspension system (not shown) is secured to the vehicle frame 16, and secures the wheels 20, 24 (FIG. 1) of the vehicle 10 to the vehicle frame 16. The suspension system provides a smooth ride by absorbing energy from various road bumps while driving, and assists the wheels 20, 24 to remain in contact with the road by increasing wheel friction. The suspension system includes various components such as upper and lower control arms, springs, shock absorbers, struts, and ball joints, for example.

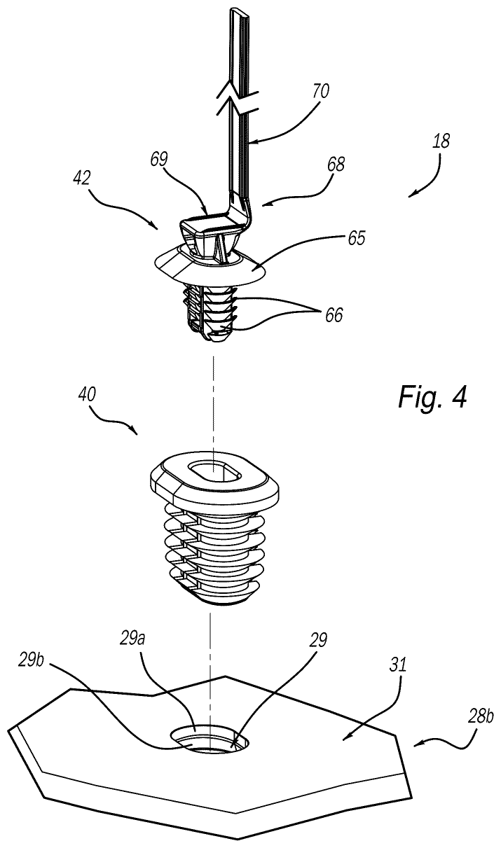

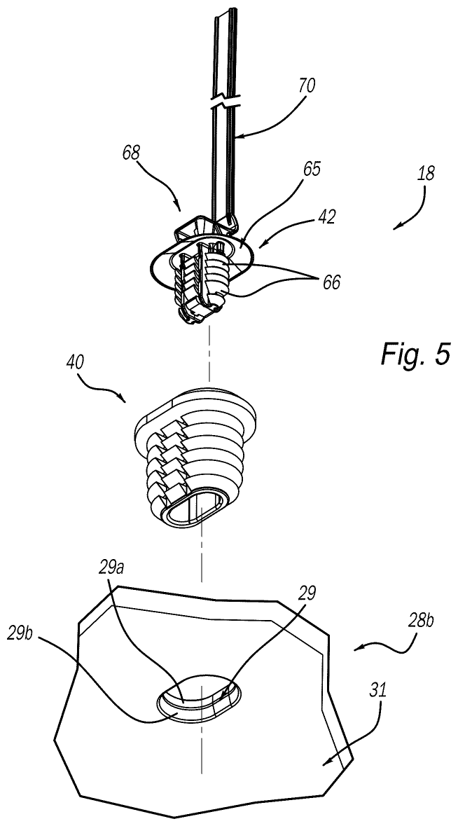

The vehicle frame 16 includes the opposed longitudinal rails 28a, 28b and cross members 32. The rails 28a, 28b are spaced apart from each other and may establish a length of the vehicle frame 16. The rails 28a, 28b are also spaced apart from a respective side of the battery structure 12. In this way, components 27 such as electrical conduits or wires, for example, may extend along and between the battery structure 12 and the rails 28a, 28b. The rails 28a, 28b may include openings 29 (FIGS. 4 and 5) extending therethrough to facilitate coupling of the components 27 to the vehicle frame 16 using the adapter structures 18 as will be described in more detail below. The cross members 32 connect the rails 28a, 28b to each other. The vehicle frame 16 does not include cross members at a center portion or mid-section thereof to accommodate the battery structure 12. The rails 28a, 28b are spaced apart a greater distance at the center portion of the vehicle frame 16 than at the ends of the vehicle frame 16. The plurality of mounts 34 are secured to and along a respective rail 28a, 28b of the vehicle frame 16 at or near the center portion of the vehicle frame 16.

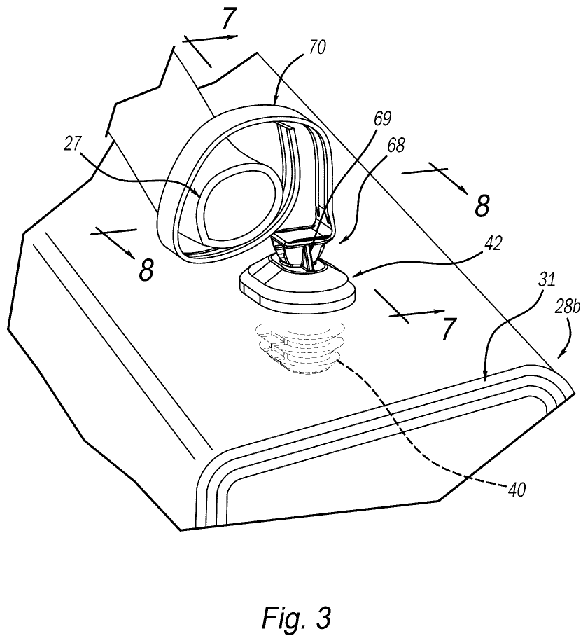

With reference to FIGS. 3-5, the adapter structures 18 are coupled to the vehicle frame 16 and are configured to secure components 27 of the vehicle 10 to the vehicle frame 16. In the example illustrated, the adapter structures 18 are spaced apart from each other and are configured to couple the component 27 to the rail 28b of the vehicle frame 16. In some forms, the adapter structures 18 are configured to couple components 27 to the rail 28a of the vehicle frame 16 or the cross members 32 of the vehicle frame 16, instead of, or in addition to, coupling the component 27 to the rail 28b of the vehicle frame 16. In other forms, the adapter structures 18 may couple components 27 to other portions of the vehicle 10 such as the vehicle body, for example.

Each adapter structure 18 includes an adapter retainer 40 and a fastener 42. The adapter retainer 40 is configured to extend through a respective opening 29 of the vehicle frame 16 so that the adapter structure 18 is coupled to the vehicle frame 16. That is, the opening 29 may extend through a side 31 of the vehicle frame 16 (e.g., an upper side of the rail 28b of the vehicle framer 16) and may include a surface having a first portion 29a (e.g., a cylindrical surface) and a second portion 29b (e.g., an angled surface) that flares outward from the first portion 29a. The adapter retainer 40 may extend through the opening 29 such that it engages with the first portion 29a and the second portion 29b and is coupled to the vehicle frame 16.

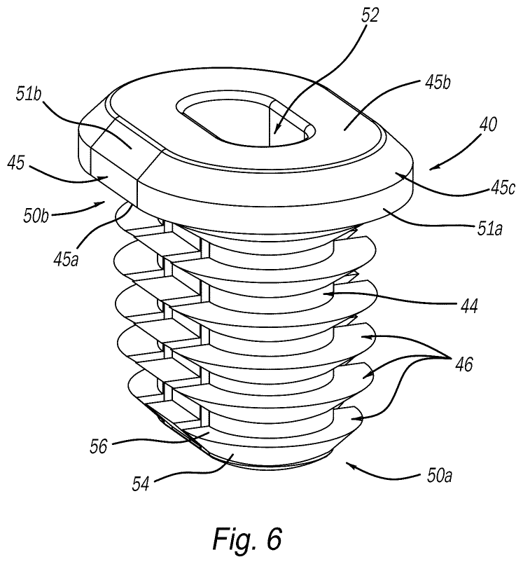

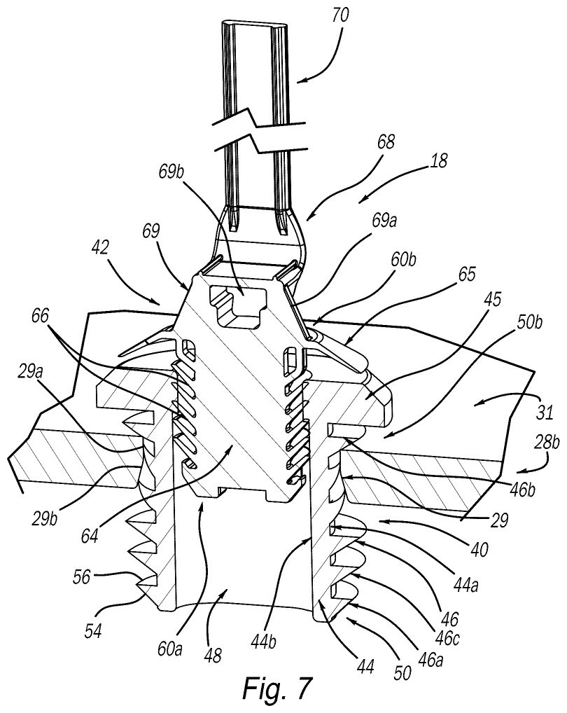

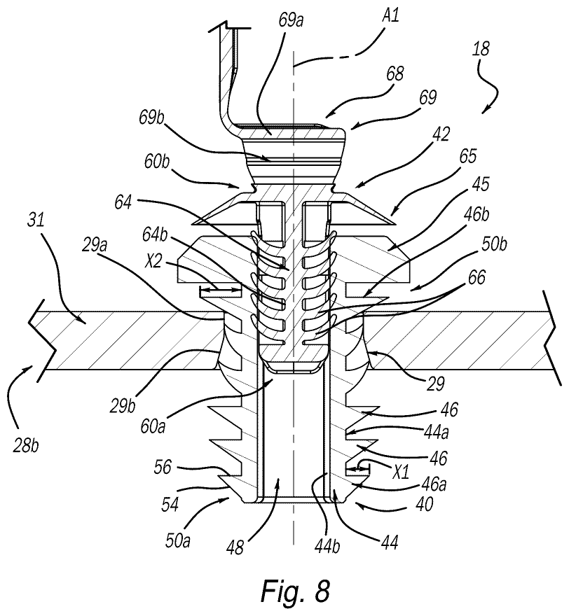

With additional reference to FIG. 6, the adapter retainer 40 includes a stem 44, a wall or flange 45, and a plurality of resiliently flexible wings or barbs 46. The stem 44 is configured to be received in the respective opening 29 of the vehicle frame 16 and defines a longitudinal axis A1 (FIGS. 7 and 8). In the example illustrated, the longitudinal axis A1 extends perpendicular to a longitudinal axis of the vehicle 10. In the example, the stem 44 has an oval shape. In some forms, the stem 44 may have a circular shape or any other suitable shape that corresponds to the shape of the respective opening 29 of the vehicle frame 16. The stem 44 further comprises an opening 48 extending at least partially therethrough along the longitudinal axis A1 and is configured to receive the fastener 42. In the example illustrated, the opening 48 has an oval shape. In some forms, the opening 48 may include a circular shape or any other shape configured to receive the fastener 42. In other forms, the opening 48 may comprise a stepped opening. In the example illustrated, the opening 48 opens through to a proximal end 50b of the stem 44 and opens through to a distal end 50a of the stem 44. In some forms, the opening 48 may not open through to the distal end 50a of the stem 44.

The stem 44 includes an inner surface 44a and an outer surface 44b that are separated from each other by a wall (material) of the stem 44. The inner surface 44a defines the opening 48 and faces in a direction opposite the outer surface 44b. The stem 44 includes a constant or uniform shape from the distal end 50a towards the proximal end 50b. The stem 44 also includes a constant thickness from the distal end 50a towards the proximal end 50b.

The wall 45 extends radially outward from or near the proximal end 50b of the stem 44 and is configured to act as a stop for the adapter retainer 40 from being further inserted into the respective opening 29 of the vehicle frame 16. Stated differently, the wall 45 is configured to engage the side 31 of the vehicle frame 16 to inhibit the adapter retainer 40 from being further inserted into the respective opening 29 of the vehicle frame 16. In the example illustrated, the wall 45 extends from the outer surface 44b of the stem 44 a further distance than the plurality of flexible wings 46. The wall 45 has a thickness that is greater than a thickness of the stem 44. In some forms, the wall 45 may have a thickness that is equal to or less than a thickness of the stem 44.

The wall 45 includes a lower surface 45a, an upper surface 45b and an outer periphery 45c. The lower surface 45 a faces towards the side 31 of the vehicle frame 16. The upper surface 45b faces away from the side 31 of the vehicle frame 16 (the upper surface 45b faces in a direction that is opposite a direction that the lower surface 45a faces) and may engage the fastener 42. The outer periphery 45c extends from the upper surface 45b towards the lower surface 45a and defines an outermost end of the wall 45. In the example illustrated, a first portion 51a of the outer periphery 45c has an arcuate surface and a second portion 51b of the outer periphery 45c has an angled surface. In some forms, the shape or profile of the outer periphery 45c may be constant from the upper surface 45b to the lower surface 45a. The wall 45 also includes an opening 52 that is in communication with the opening 48 of the stem 44 and that is configured to receive the fastener 42. In the example illustrated, the opening 52 has a diameter that is smaller than a diameter 48 of the stem 44. In some forms, the opening 52 may have a diameter that is equal to or greater than the diameter 48 of the stem 44.

The plurality of flexible wings 46 extend radially outward from the outer surface 44b of the stem 44 and are configured to engage the surface of the respective opening 29 to couple the adapter retainer 40 to the vehicle frame 16. The flexible wings 46 also extend at least partially around the outer surface 44b of the stem 44. In the example illustrated, each flexible wing 46 extends around the outer surface 44b in a discontinuous arrangement. In some forms, each flexible wing 46 extends around the outer surface 44b in a continuous arrangement.

With reference to FIGS. 7 and 8, the flexible wings 46 are spaced apart from each other along the stem 44. Stated differently, the flexible wings 46 are spaced apart from the distal end 50b of the stem 44 toward the proximal end 50a of the stem 44. A first flexible wing 46a of the plurality of flexible wings 46 extends radially outward from or near the distal end 50a of the stem 44 a first distance X1 and a second flexible wing 46b of the plurality of flexible wings 46 extends radially outward from or near the proximal end 50b of the stem 44 a second distance X2. The second distance X2 is greater than the first distance X1. The plurality of flexible wings 46 extend further from the stem 44 in a radial direction as the plurality of flexible wings 46 move closer from the distal end 50a of the stem 44 toward the proximal end 50b of the stem 44. Stated differently, the flexible wing 46c located at a central portion of the stem 44 may extend radially outward from the stem 44 a greater distance than the flexible wing 46a and the flexible wing 46b located at or near the proximal end 50a of the stem 44 may extend radially outward from the stem 44 a greater distance than the flexible wing 46c. In this way, the flexible wings 46 located near the proximal end 50a of the stem 44 may still engage the second portion 29b of the opening 29, thereby permitting coupling of the retainer adapter 40 to the vehicle frame 16.

In the example illustrated, each flexible wing 46 includes an angled surface 54 and a flat, upper surface 56. The angled surface 54 is configured to engage the surface 25 of the respective opening 29 of the vehicle frame 16 as the adapter retainer 40 is being inserted into the respective opening 29, thereby causing the flexible wing 46 to flex or bend toward the stem 44. Once the flexible wing 46 clears the respective opening 29, the flexible wing 46 may return to its original shape. The upper surface 56 of one or more wings 46 may engage a lower surface of the side 31 of the vehicle frame 16, thereby inhibiting the adapter retainer 40 from being removed (e.g., pulled out) from the respective opening 29 of the vehicle frame 16. It should be understood that the profile of the wings 46 disclosed herein are for exemplary purposes and the wings may have different profiles without departing from the scope of the present disclosure.

The fastener 42 is configured to extend at least partially through the opening 48 of the adapter retainer 40 so that the fastener 42 is coupled to the adapter retainer 40. That is, the fastener 42 may extend through the opening 48 such that it engages the inner surface 44a of the stem 44 and is coupled to the adapter retainer 40. In the example illustrated, the fastener 42 extends partially through the opening 48 of the stem 44. In some forms, the fastener 42 may extend through the opening 48 of the stem 44.

The fastener 42 includes a stem 64, a wall or flange 65, and a plurality of resiliently flexible wings or barbs 66. The stem 64 is configured to be received in the opening 48 of the adapter retainer 40. In the example, the stem 64 has a solid shape. In some forms, the stem 64 may have a circular shape or any other suitable shape that is allowed to be received in the opening 48 of the adapter retainer 40. The stem 64 includes an outer periphery or surface 64b (FIG. 7). The stem 64 further includes a distal end 60a and the proximal end 60b. In one form, the stem 64 includes a constant or uniform shape from the distal end 60a towards the proximal end 60b. In another form, the stem 64 may include a variable shape or thickness from the distal end 60a towards the proximal end 60b.

The wall 65 extends outward from or near the proximal end 60b of the stem 64 and is configured to act as a stop for the fastener 42 from being further inserted into the opening 48 of the adapter retainer 40. Stated differently, the wall 65 is configured to engage the wall 45 of the adapter retainer 40 to inhibit the fastener 42 from being further inserted into the opening 48 of the adapter retainer 40. In the example illustrated, the wall 65 extends outward from the stem 64 a further distance than the plurality of flexible wings 66 and is located inwardly of the outer periphery 45c of the wall 45 (i.e., the wall 45 extends radially outwardly a further distance than the wall 65). The wall 65 has a thickness that is smaller than a thickness of the stem 64 and smaller than the thickness of the wall 45. In some forms, the wall 65 may have a thickness that is equal to or greater than a thickness of the stem 64. In the example illustrated, the wall 65 has a concave shape. In some forms, the wall 65 may include a convex shape or any other suitable shape that permits engagement with the wall 45 of the adapter retainer 40.

The plurality of flexible wings 66 extend radially outward from the outer surface 64b of the stem 64 and are configured to engage the inner surface 44b of the opening 48 of the adapter retainer 40 to couple the fastener 42 to the adapter retainer 40. The flexible wings 66 extend at least partially around the outer surface 64b of the stem 64 and may extend from the stem 64 at an acute or obtuse angle. In the example illustrated, each flexible wing 66 extends around the outer surface 64b in a discontinuous arrangement. In some forms, each flexible wing 66 extends around the outer surface 64b in a continuous arrangement. The flexible wings 66 are spaced apart from each other along the stem 64. Stated differently, the flexible wings 66 are spaced apart from the distal end 60b of the stem 64 toward the proximal end 60a of the stem 64.

The fastener 42 includes a locking mechanism 68 that secures the components 27 of the vehicle 10 to the vehicle frame 16 (FIG. 3). In the example illustrated, the locking mechanism 68 includes a retention feature 69 and an elongated strap or tab 70. The retention feature 69 extends from the wall 65 and includes a body 69a defining an opening 69b extending therethrough. The strap 68a extends from the body 69a and is configured to be wrapped around one or more components 27 and inserted into the opening 69b in such a way that it inhibits removal of the tab 70 from the opening 69b. In this way, the components 27 are secured to the vehicle frame 16. It should be understood that the locking mechanism 68 described above is an example locking mechanism and the fastener 42 may include various types of locking mechanisms to secure the components 27 of the vehicle 10 to the vehicle frame 16 without departing from the scope of the present disclosure.

Although the vehicle 10 illustrated herein is of a body-on-frame architecture, the adapter structure 18 may be used on other vehicles such as a vehicle having a uni-body construction without departing from the scope of the present disclosure. It should also be understood that although the vehicle 10 illustrated is an electric vehicle, the adapter structure 18 may be used on other vehicle types such as a vehicle having an internal combustion engine (ICE) without departing from the scope of the present disclosure.

The adapter structure 18 of the present disclosure provides the benefit of allowing components to be secured to vehicle structures (e.g., the vehicle frame 16) having variable shaped openings (e.g., V-shaped or other non-uniform shapes). For example, when manufacturing high strength steel vehicle frames, the openings formed may have a non-uniform shape. It is desired for fasteners or clips that secure components to the vehicle frame to accommodate the non-uniform shape opening so as to retain the component to the vehicle frame when assembled. The adapter structure 18 of the present disclosure provides the benefit of allowing different components to be secured to vehicle frame without having to tool multiple clips or fasteners to accommodate the non-uniform shape opening in the vehicle frame.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An adapter structure for a first opening in a frame, the adapter structure comprising:
a stem configured to be received in the first opening of the frame and defining a longitudinal axis, the stem comprising a second opening extending at least partially therethrough along the longitudinal axis and configured to receive a fastener; and
a plurality of flexible wings extending radially outward from the stem.

2. The adapter structure of claim 1, wherein the stem includes a distal end and a proximal end, and wherein the stem comprises a constant shape from the distal end towards the proximal end.

3. The adapter structure of claim 1, further comprising a wall extending radially outward from a proximal end of the stem a further distance than the plurality of flexible wings.

4. The adapter structure of claim 3, wherein the wall defines a third opening that is in communication with the second opening and that is configured to receive the fastener.

5. The adapter structure of claim 1, wherein a first flexible wing of the plurality of flexible wings extends radially outward from or near a distal end of the stem a first distance and a second flexible wing of the plurality of flexible wings extends radially outward from or near a proximal end of the stem a second distance, and wherein the second distance is greater than the first distance.

6. The adapter structure of claim 1, wherein the stem includes a distal end and a proximal end, and wherein the stem has a constant thickness from the distal end towards the proximal end.

7. The adapter structure of claim 1, wherein the plurality of flexible wings extend further from the stem in a radial direction as the plurality of flexible wings move closer from a distal end of the stem toward a proximal end of the stem.

8. The adapter structure of claim 1, wherein the stem has an oval shape.

9. The adapter structure of claim 1, wherein the stem includes an inner surface that defines the second opening and an outer surface, and wherein the plurality of flexible wings extend radially outward from the outer surface of the stem.

10. The adapter structure of claim 1, further comprising the fastener.

11. An adapter structure for a first opening in a frame, the adapter structure comprising:
a first stem configured to be received in the first opening of the frame and defining a longitudinal axis, the first stem comprising a second opening extending at least partially therethrough along the longitudinal axis;
a plurality of first flexible barbs extending radially outward from the first stem; and
a fastener including a second stem and a plurality of second flexible barbs extending radially outward from the second stem, a portion of the second stem and the plurality of second flexible barbs at least partially received in the second opening.

12. The adapter structure of claim 11, wherein the first stem includes a distal end and a proximal end, and wherein the first stem comprises a constant shape from the distal end towards the proximal end.

13. The adapter structure of claim 11, further comprising a first wall extending radially outward from a proximal end of the first stem a further distance than the plurality of first flexible barbs.

14. The adapter structure of claim 13, further comprising a second wall extending outward from an end of the second stem a further distance than the plurality of second flexible barbs.

15. The adapter structure of claim 13, wherein the first wall defines a third opening that is in communication with the second opening and that is configured to receive the portion of the second stem and the plurality of second flexible barbs.

16. The adapter structure of claim 11, wherein a first flexible barb of the plurality of first flexible barbs extends radially outward from or near a distal end of the first stem a first distance and a second flexible barb of the plurality of first flexible barbs extends radially outward from or near a proximal end of the first stem a second distance, and wherein the second distance is greater than the first distance.

17. The adapter structure of claim 11, wherein the plurality of first flexible barbs extend further from the first stem in a radial direction as the plurality of first flexible barbs move closer from a distal end of the first stem toward a proximal end of the first stem.

18. The adapter structure of claim 11, wherein the first stem includes an inner surface that defines the second opening and an outer surface, and wherein the plurality of first flexible barbs extend radially outward from the outer surface of the first stem.

19. The adapter structure of claim 18, wherein the plurality of second flexible barbs engage the inner surface of the first stem.

20. A vehicle comprising:
a vehicle frame defining a first opening; and
an adapter structure comprising:
a first stem configured to be received in the first opening of the vehicle frame and defining a longitudinal axis, the first stem comprising a second opening extending at least partially therethrough along the longitudinal axis;
a plurality of first flexible barbs extending radially outward from the first stem; and
a fastener including a second stem and a plurality of second flexible barbs extending outward from the second stem, a portion of the second stem and the plurality of second flexible barbs at least partially received in the second opening such that the plurality of second flexible barbs engage an inner surface defining the second opening,
wherein a first flexible barb of the plurality of first flexible barbs extends radially outward from or near a distal end of the first stem a first distance and a second flexible barb of the plurality of first flexible barbs extends radially outward from or near a proximal end of the first stem a second distance, and wherein the second distance is greater than the first distance.
